(19) United States
(12) Patent Application Publication
(10) Pub. No.: US 2011/0049182 A1
(43) Pub. Date: Mar. 3, 2011

(54) DISPENSING APPARATUS

(76) Inventors: Theodore R. Smith, Sarasota, FL (US); Kristine Helm Smith, Sarasota, FL (US); Rodney G. Smith, Sarasota, FL (US)

(21) Appl. No.: 12/872,742

(22) Filed: Aug. 31, 2010

Related U.S. Application Data
(60) Provisional application No. 61/238,532, filed on Aug. 31, 2009.

(51) Int. Cl. B67D 1/00; B65D 83/00

(52) U.S. Cl. 222/61; 222/394

(57) ABSTRACT

An apparatus for dispensing a beverage may include separate pressure regulators to independently control pressure at a beverage source and also at a beverage pump. The pump may function to drive/draw a beverage (such as a beer) from a source to a dispensing station. In operation, the apparatus may be configured to transmit a pressurized gas from a source through one regulator and then to the beverage source, with the regulator functioning to control the pressure at the beverage source. The apparatus may also be configured to transmit gas from the source, through the other regulator, and then to the pump, with that other regulator functioning to maintain pressure in the system as the beverage travels from the pump to the dispensing station. This dual pressure control allows a user to maintain a beverage at a consistent pressure when traveling from the beverage source to a dispensing station.

### CROSS-REFERENCE TO RELATED APPLICATIONS

The present application claims priority from U.S. Provisional Application No. 61/238,532, filed Aug. 31, 2009, the disclosure of which is incorporated by reference herein it its entirety.

### FIELD OF THE INVENTION

An apparatus is disclosed for dispensing a beverage under pressure. The apparatus may include the use of separate pressure regulators to independently control pressure at a beverage source and also at a beverage pump. This dual pressure control may allow a user to maintain a beverage at its natural pressure as it travels from the source to a dispensing station.

### BACKGROUND OF THE INVENTION

Many beverages (e.g., beer) can become over carbonated when exposed to high pressure. In fact, as little as two (2) lbs of extra pressure in a dispensing system relative to the natural pressure of a beverage (e.g., keg pressure or the pressure at the source) can result in the over carbonation of a beer. On-site beverage distribution systems typically use pumps or high pressure gas to drive a beverage from a source (e.g., a keg, a brew pub vat or kettle and/or a cask) to a dispensing station. A problem, however, is that the pressures used in these systems, and their configuration, also tends to over carbonate the beverage.

In a traditional blended gas dispensing system, for example, a source of pressurized gas (blended e.g., 50/50 or 60/40 CO₂ and Nitrogen) may be used to drive beer from a keg to a dispensing station. This use of a blended gas is intended to decrease carbonation. However, as the beer in a keg is displaced by gas, the high pressure CO, used by these systems has still been found to result in an increase in system pressure and in an over carbonation of the beer.

In systems that rely on pumps to drive a beverage, a single regulator is often used to control pressure at both the beverage source and the pump. Or, alternatively, one regulator may be used to control pressure at multiple beverage sources, and a second regulator may be used to control pressure for multiple downstream lines. However, these systems are either ineffective at controlling pressure throughout an entire system (caused, e.g., by a pressure differential between the downstream pump pressure and the pressure at the beverage source) or they fail to account for the fact that each beverage in a group may have a different natural pressure. Stated differently, these prior art systems are unable to effectively balance the pressures of multiple beverage sources at the same time, resulting in significant differences in pressure and agitation of the beverage(s).

When a beer is over carbonated it generates foam, and foam may translate into a lower overall yield per keg. More important for a user, however, is that a lower yield can mean a lower profit per keg. Therefore, it would be advantageous to have a system that can maintain each beverage (e.g., beer) at its natural pressure as it travels from a source (e.g., a keg) to a dispensing station. Maintaining a beverage at the same pressure from its source point until it is dispensed would reduce or eliminate over carbonation of the beverage, increase per keg yields, and increase the potential per keg profit for a user. Indeed, in field tests, a user of an embodiment of an apparatus disclosed herein experienced a 4% decrease in beer related costs following installation of the apparatus in place of a traditional pump system. Users of traditional blended gas systems have been found to experience a 6 to 12% decrease in beer related costs following installation of the apparatus in place of those systems.

### SUMMARY OF THE INVENTION

An apparatus is disclosed for dispensing a beverage under pressure. The apparatus may include the use of separate pressure regulators to independently control pressure at a beverage source and also at a beverage pump. This dual pressure control may allow a user to maintain each beverage at the same pressure (e.g., the keg pressure) as the beverage travels from the source to a dispensing station.

A beverage dispensing apparatus may include a pump for driving/drawing a beverage (such as a beer) from a beverage source to a beverage dispensing station. As mentioned supra, a first pressure regulator may be provided to regulate pressure at the beverage source. A second pressure regulator may also be provided to regulate beverage pressure as the beverage travels from the pump to the dispensing station.

In operation, a source of pressurized gas may be configured to transmit a gas through the first regulator and then to the beverage source, with the first regulator functioning to control the pressure of the beverage at the beverage source to maintain the beverage at its natural or predetermined pressure (i.e., keg pressure). The source of pressurized gas may also be configured to transmit a gas through the second regulator and then to the pump, with the second regulator functioning to maintain a beverage in the system at its natural or predetermined pressure as it travels from the pump to the dispensing station. A foam control detector (FOB) may also be provided downstream of the pump to control foam buildup in a downstream line.

### BRIEF DESCRIPTION OF THE DRAWINGS

Reference will now be made to the attached drawing wherein like reference numerals refer to like parts throughout and wherein:

FIG. 1 is a planar front view of an embodiment of a dispensing apparatus constructed in accordance with the present invention;

FIG. 2 is planar rear view of the embodiment of the dispensing apparatus shown in FIG. 1;

FIG. 3 is a environmental view of multiple dispensing apparatus, with each apparatus configured to conduct a beverage from a single beverage source to a beverage dispensing station.

### DETAILED DESCRIPTION OF THE INVENTION

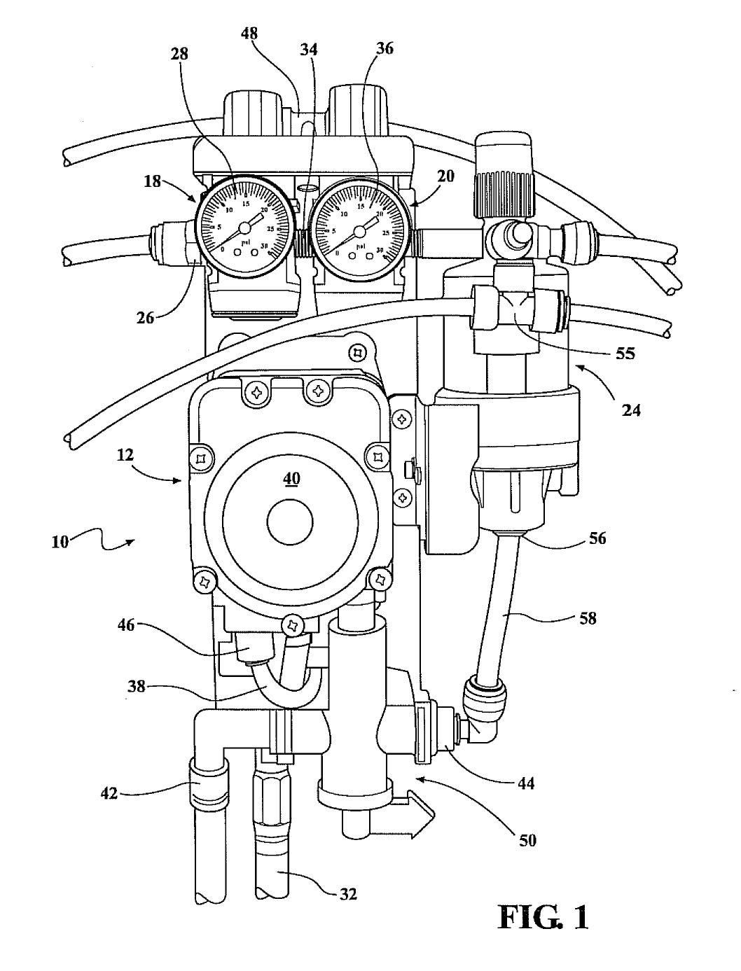

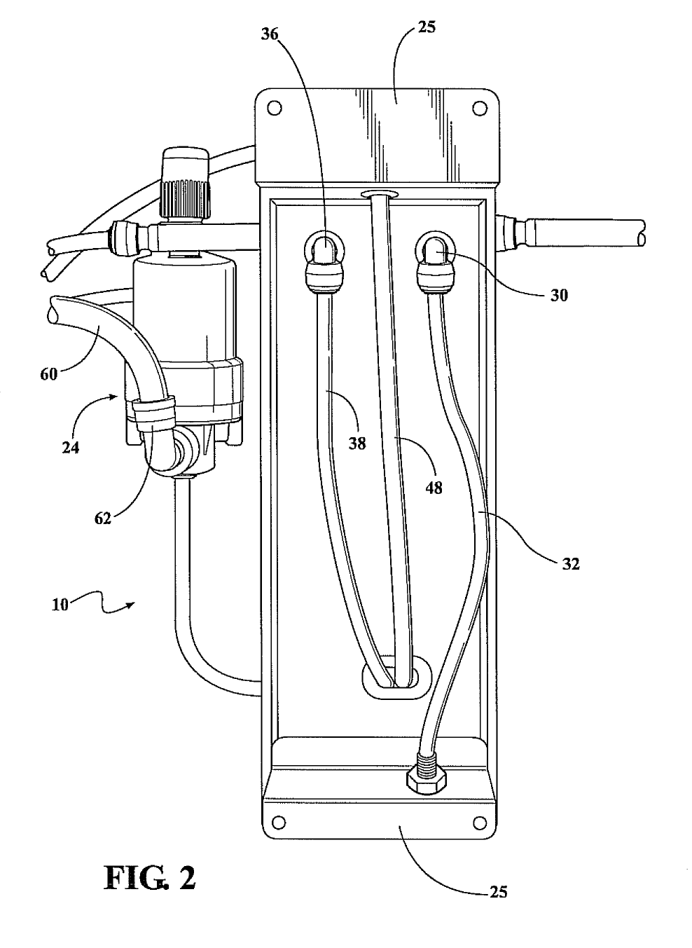

Referring now to FIGS. 1-3, a beverage dispensing apparatus (or system) 10 may include a pump 12 that may operate to drive/draw a beverage (not shown) such as a beer from a beverage source 14 or container to a beverage dispensing station 16. An upstream or first pressure regulator 18 may be provided to regulate pressure at the beverage source 14 with another (downstream) or second pressure regulator 20 being provided to regulate pressure in the apparatus 10 as the beverage travels from the pump 12 to the dispensing station 16. A source of pressurized gas 22 may be configured to communicate with each regulator 18, 20, and with the pump 12 and beverage source 14 through their respective regulator 18, 20. A foam control detector (FOB) 24 may also be provided downstream of the pump 12 to control for foam buildup. As best shown in FIG. 2, the apparatus 10 may be secured to a wall or like surface using a mounting bracket 25.

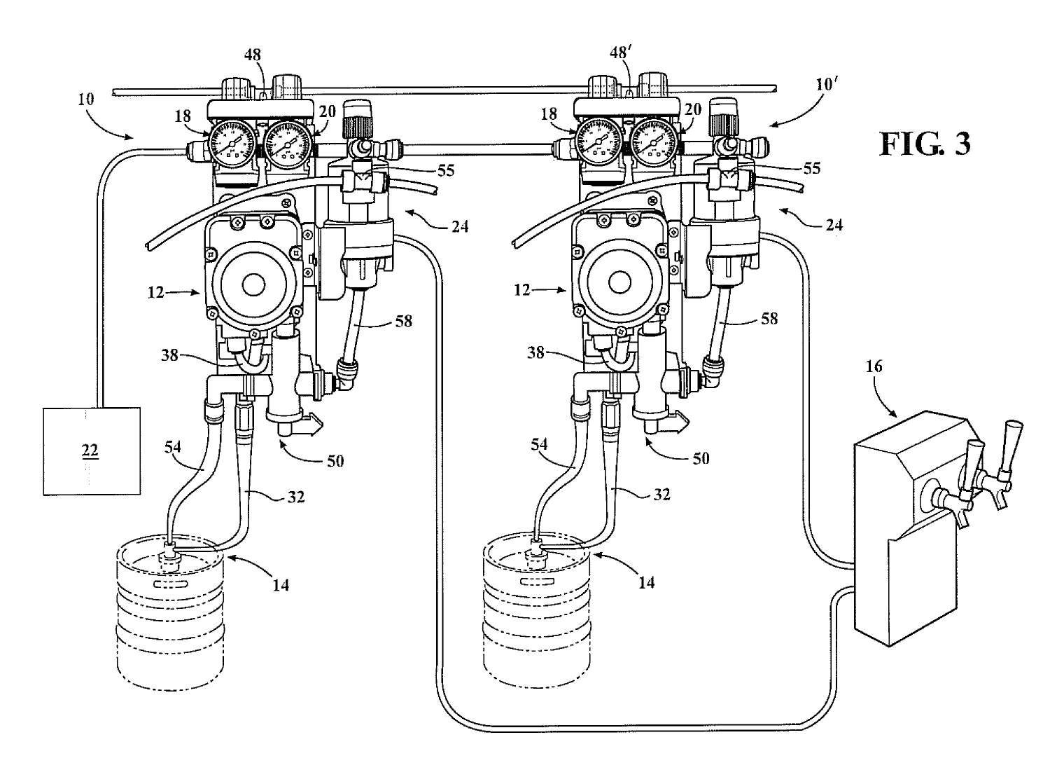

Referring now to FIGS. 1 and 3, the first pressure regulator 18 (which controls pressure at the beverage source 14) and the second pressure regulator 20 (which controls pressure at and downstream of the pump 12) may be a WILKERSON® brand regulator. More specifically, the first and second regulators 18, 20 may each be a Common-P1 Regulator Model 09-02 regulator manufactured by the Wilkerson Corporation.

Referring now to FIGS. 1-3, the first pressure regulator 18 may have an inlet 26 in communication with the source of pressurized gas 22, and a pair of outlets. One outlet (not shown) may communicate with a gauge 28 on the first regulator 18 to permit a user to visually monitor pressure. The other outlet 30 may communicate with the beverage source 14 via a line 32. In addition, a conduit (not shown) may be provided through the body of the regulator 18. As shown in FIG. 3, this conduit (not shown) allows a user to position several regulators in series and to otherwise save space by permitting (unregulated) gas to be communicated directly from the source of pressurized gas 22, through the body of the first regulator 18, and then on to, for example, the second pressure regulator 20.

Still referring to FIGS. 1-3, the second pressure regulator 20 may also have an inlet 34 in communication with the source of pressurized gas 22, and a pair of outlets. One outlet (not shown) may communicate with a gauge 36 on the regulator 20 to permit a user to visually monitor pressure. The other outlet 36 may communicate with the pump 12 via a line 38. The second pressure regulator 20 may also have a conduit (not shown) that, like conduit of the first regulator 18, may extend through the body of the regulator 20. However, an outlet (not shown) of the conduit for the second regulator 20 may be plugged. Additionally, or alternatively, as shown in FIG. 3 where multiple apparatus 10 are connected in series to a single gas source 22, the conduit (not shown) may be plugged in the second pressure regulator 20 on the terminal apparatus 10′. In operation, it will be appreciated that the use of two separate regulators 18, 20 allows the apparatus 10 to have a consistent pressure throughout the length of the apparatus 10—from beverage source 14 to the dispensing station 16—resulting in less agitation of the beverage and a higher overall yield per beverage source (e.g., per keg).

Still referring to FIGS. 1-3, the source of pressurized gas 22 may be a traditional CO₂ supply source (e.g., tank). This source of pressurized gas 22 may be connected to the beverage source 14 through the first pressure regulator 18 using traditional gas transmission conduit.

Still referring to FIGS. 1-3, the beverage source 14 or container may be a traditional beer keg, the contents of which are under a natural pressure (i.e. the keg pressure). Moreover, as described supra, the beverage source 14 is also in communication with the gas source 22 though the first regulator 18. It will also be appreciated that other beverages and beverage sources or containers may be used in connection with the beverage distribution apparatus 10, including kegs containing different brands of beer, different types of beer, and other beverages that are stored at different natural pressures and/or may have different viscosities or other physical characteristics.

Still referring to FIGS. 1-3, the pump 12 may be a gas operated beverage pump having a housing that may include a pump assembly 40, a beverage inlet 42, a beverage outlet 44 and a gas inlet 46. The pump may also be configured to include a vent 48 and/or pressure relief line. As shown in FIG. 3, this vent 48 may be connected with the vents 48′ of any upstream or downstream pumps 12 where multiple apparatus 10 are connected in series.

Examples of a suitable beverage pump include the FLOJET® G56 series (beer) gas (CO₂)/air driven pump, which may optionally include a flow reversal valve 50 such as the FLOJET® model FRV1000. It will, however, be appreciated that other brands and models of beverage pump may be used in connection with the beverage dispensing system 10. It will also be appreciated that, as the name implies, the flow reversal valve may be operated by a user to reverse the flow of fluid through the pump 12. Flow reversal permits a user to clean the entire beverage dispensing system 10 from the beverage dispensing station 16. Specifically, by introducing a cleaning solution (not shown) at the dispensing station 16, and then reversing the flow of the pump 16, the solution is easily drawn from the station 16, though the FOB 24 and then out through the input port of the pump 12. As best shown in FIGS. 2 and 3, a beverage may travel from an outlet 52 of the beverage source 14 via a line 54 to the inlet 44 of the pump 12.

Still referring to FIGS. 1 and 2, the FOB 24 may be a Model 6720 mM wall mounted foam control detector with beer fitting threads. Although, it will be appreciated that other FOBs may be used. Like the pump 12, a vent or pressure relief 55 line may also be provided in the FOB 24. Where multiple apparatus 10 are connected in series it will be appreciated that this vent may also be connected with the vents of any upstream or downstream FOBs. It will also be appreciated that the FOB 24 is an optional feature. As best shown in FIG. 1, a beverage may enter the FOB 24 through an inlet 56 via a line 58 from the outlet 44 of the pump 12. Also, as best shown in FIG. 2, a beverage may travel from the FOB 24 to the dispensing station 16 via a line 60 extending from an outlet 62 of the FOB 24.

Finally, the beverage dispensing station 16 may be any one of a number of the beer and other beverage dispensing system that are well known in the art including, for example, a beer engine or a beer tower.

Having now described one embodiment of a beverage dispensing system 10, various additional embodiments will become apparent to those of skill in the art that do not depart from the scope of the claims set forth below.

I claim:

1. A beverage dispensing apparatus comprising:
a source of pressurized gas;
a first pressure regulator and a second pressure regulator, each pressure regulator communicating with the source of pressurized gas;
a pump having a beverage inlet, a beverage outlet and a gas inlet, the gas inlet communicating with the second pressure regulator;
a beverage source having a gas inlet and a beverage outlet, the gas inlet communicating with first pressure regulator, and the beverage outlet of the beverage source communicating with the beverage inlet of the pump;
a foam control detector having an inlet and an outlet, the inlet of the foam control detector communicating with the beverage outlet of the pump; and
a beverage dispensing station in communication with the outlet of the foam control detector.

2. The apparatus of claim 1, wherein the beverage source is a keg of beer.

3. The apparatus of claim 1, wherein the beverage source is a cask.

4. The apparatus of claim 1, wherein the beverage source is a vat.

5. The apparatus of claim 1, wherein the beverage dispensing station is a beer tower.

6. The apparatus of claim 1, wherein the beverage dispensing station is a beer engine.

7. The apparatus of claim 1, wherein the pump comprises a flow reversal valve.

8. A beverage dispensing apparatus comprising:
a first pressure regulator and a second pressure regulator, the first pressure regulator having an inlet, an outlet and a body defining a conduit that extends through the regulator, the second pressure regulator having a inlet and an outlet, the inlet of the second pressure regulator communicating with one end of the conduit of the first pressure regulator so that a gas may be transmitted through the first pressure regulator and to the inlet of the second pressure regulator;
a gas operated beverage pump including a flow reversal valve and a gas inlet, the gas inlet communicating with the outlet of the second pressure regulator, and the flow reversal valve having a beverage inlet and a beverage outlet; and
a foam control detector having an inlet and an outlet, the inlet of the foam control detector communicating with the beverage outlet of the pump.

9. A beverage dispensing apparatus comprising:
a source of pressurized gas;
at least two first pressure regulators and at least two second pressure regulators, each pressure regulator communicating with the source of pressurized gas;
at least two pumps, each pump having a liquid inlet, a liquid outlet and a gas inlet, the gas inlet of each pump communicating with one of the second pressure regulators and each of the second pressure regulators communicating with only one of the pumps;
at least two beverage sources, each beverage source having a gas inlet and a beverage outlet, the gas inlet communicating with one of the first pressure regulators and each of the first pressure regulators communicating with only one of the beverage sources;
a beverage dispensing station in communication with the beverage outlet of at least one of the pumps.

10. The apparatus of claim 9, wherein the at least two beverage sources comprise at least two different beverages.

11. The apparatus of claim 10, wherein the at least two different beverages are two different varieties of beer.

12. The apparatus of claim 9, wherein each pump comprises a flow reversal valve.

13. The apparatus of claim 9, comprising at least two foam control detectors, each detector having an inlet and an outlet, with the inlet of each detector communicating with the liquid outlet of one of the pumps and the outlet of each detector communicating with the beverage dispensing station.

14. The apparatus of claim 9, wherein the beverage dispensing station is a beer tower.

15. The apparatus of claim 9, wherein the beverage source is a keg of beer.

16. The apparatus of claim 9, wherein the beverage source is a cask.

17. The apparatus of claim 9, wherein the beverage source is a vat.
